(19) United States
(12) Patent Application Publication
(10) Pub. No.: US 2007/0164136 A1
(43) Pub. Date: Jul. 19, 2007

(54) Cutting tool pertaining to a centrifugal pump

(76) Inventors: Manfred Zelder, Bonn (DE); Michael Muller, Wolfratshausen (DE)

Correspondence Address: K.F. ROSS P.C., 5683 RIVERDALE AVENUE, SUITE 203 BOX 900, BRONX, NY, 10471-0900, US

(21) Appl. No.: 10/589,644

(22) PCT Filed: Jan. 11, 2005
(86) PCT No.: PCT/EP05/00150

§ 371 Date: Aug. 15, 2006

(30) Foreign Application Priority Data
Feb. 16, 2004 (DE) 10 2004 007 739.8

(51) Int. Cl. B02C 23/00

(52) U.S. Cl. 241/46.06

(57) ABSTRACT

The invention relates to a cutting tool pertaining to a centrifugal pump for liquids loaded with solids. Said cutting tool comprises a rotating cutting body comprising at least one opening forming a cutting edge and through which the liquid flows, the lateral surface of the cutting body facing the rotationally fixed opposite surface that also comprises at least one opening through which the liquid flows. The lateral surface of the cutting body, facing the opposite surface, is curved in a convex manner, and the opposite surface is curved in a correspondingly concave manner.

The invention relates to a cutter of a rotary pump for liquids containing solid materials, the cutter having a rotating blade having at least one opening through which the liquid flows and that forms a cutting edge, and wherein the blade has one end face directed toward a nonrotating counter surface that also has at least one opening through which the liquid passes.

It is known to provide the impeller of a rotary pump with a cutter mounted on its inlet for comminuting solids contained in the transported liquid for the pump so the downstream pipes and devices are not plugged. In these rotary pumps, the impeller shaft normally is supported only adjacent the drive motor, so that the cutter vibrates on the shaft bearing that is near the pump impeller while cutting the solids to small pieces. In addition, during operation of rotary pumps, a radial force is applied on the impeller that thus applies an alternate bending to the impeller shaft. Due to this fact, friction occurs at least between the outer end faces of the rotating blade and the counter surface of the abutting, nonrotating element, as well as often in the outer edge, so that premature wear results. On the side that is diametrally opposite the friction point, the clearance is enlarged and thus, the danger of plugging due to solids that have not been cut is increased.

The object of the invention is improving a cutter of a rotary pump such that low wear occurs while at the same time providing high cutting performance.

This object is attained according to the invention by the fact that the end face that is directed at the counter surface of the blade is convex and the counter surface is also concave.

Such a cutter has low wear since the surfaces can slide past each other without contact. This way, it is also assured that the cutter and the pump are not plugged and in particular long foreign bodies do not wrap around the blade and the impeller. When supported in a safe manner, it is easy to fabricate and assemble such cutter and a rotary pump.

Advantageous designs of the invention are cited in the dependent claims.

Two embodiments of the invention are represented in the drawings and will be described in detail in the following. In the drawings:

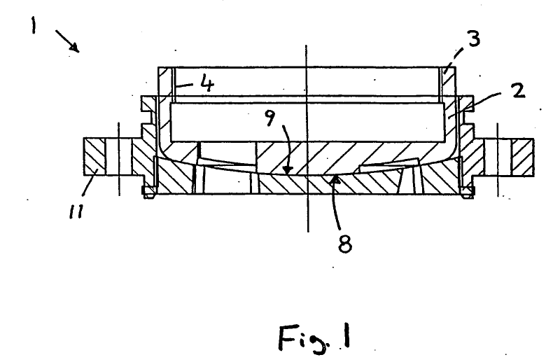

FIG. 1 is an axial section through a cutter of a first design;

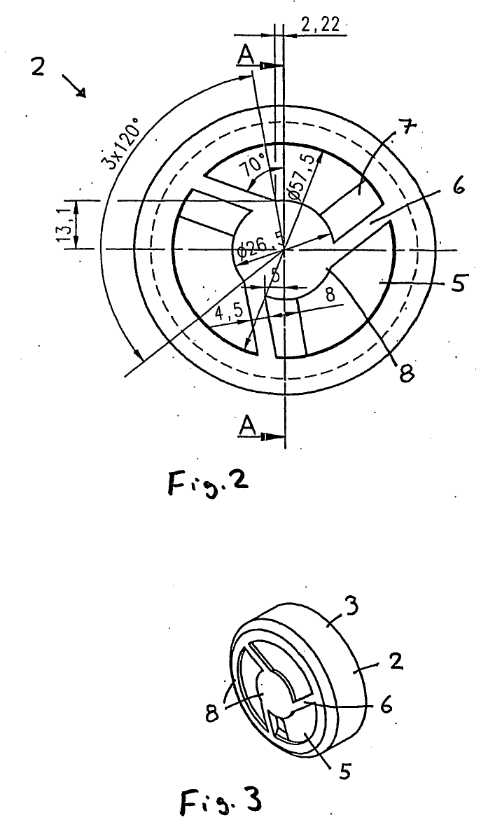

FIG. 2 is an end view of the rotating blade according to FIG. 1;

FIG. 3 is a perspective view of the rotating blade in reduced scale;

FIG. 4 is an end view of the nonrotating element;

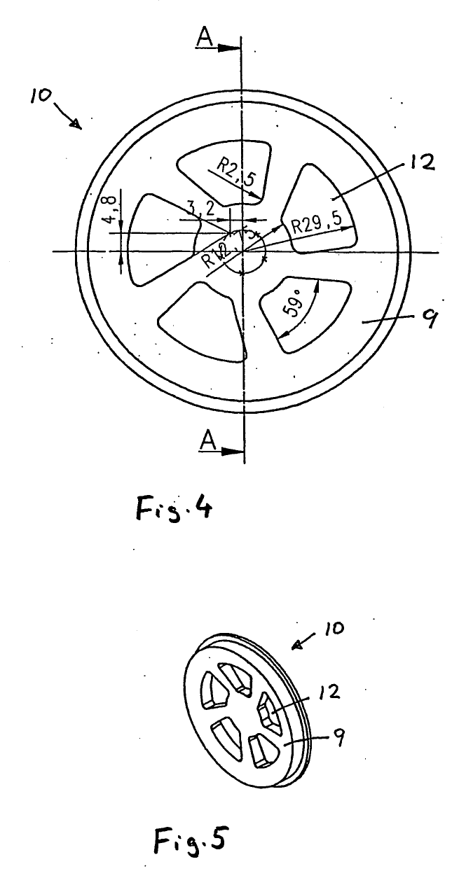

FIG. 5 is a perspective view of the nonrotating element in reduced scale;

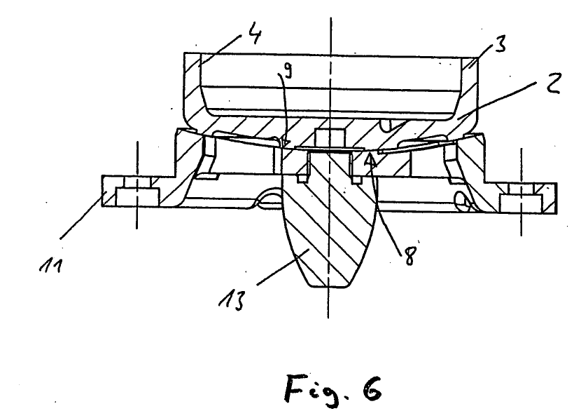

FIG. 6 is an axial section of the cutter of a second design;

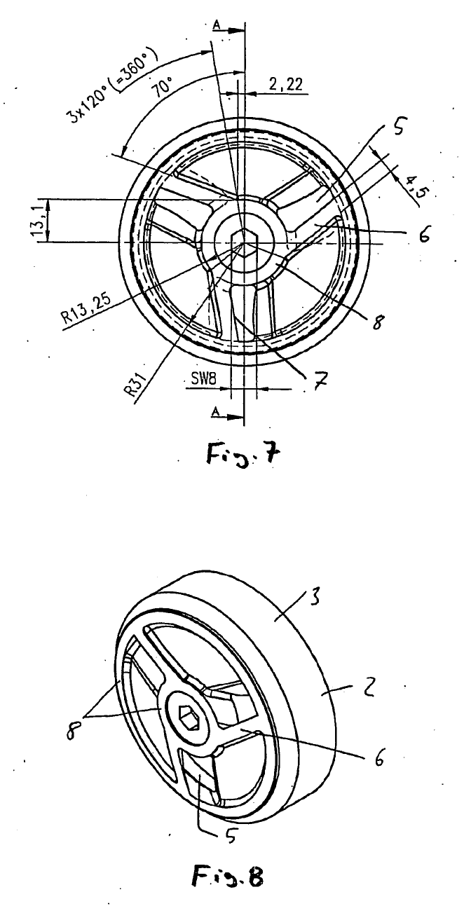

FIG. 7 is an end view of the rotating blade according to FIG. 6;

FIG. 8 is a perspective view of the rotating blade according to FIG. 7;

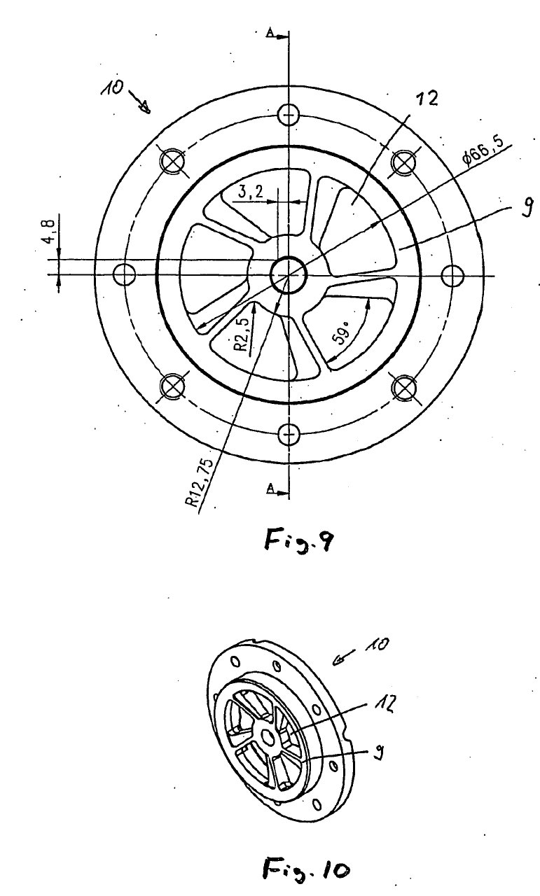

FIG. 9 is an end view of the nonrotating element of the second design;

FIG. 10 is a perspective view of the nonrotating element of the second design in reduced scale.

The cutter 1 of a rotary motor pump has a rotating blade 2 that is attached on the end of the pump impeller that is directed away from the electric drive motor. The blade 2 is designed cup-shaped and its upper edge surrounds the bush-shaped inlet opening of the impeller. Herein, the upper edge 3 preferably has an internal thread 4 or a press fit by means of which it can be screwed onto or pressed into the external thread or the cylindrical support of the impeller inlet opening.

The bottom of the blade 2 has three inlet openings 5 that are separated from each other by means of webs 6 on which radial cutting edges 7 are attached, in particular molded thereto. The cutting edges 7 thus form angles of 120° with each other.

The inlet openings 5 are shaped to extend at an angle to the rotational direction and thus, are set diagonal relative to the rotational axis, so that the blade 2 has the function of an “axial impeller.”

The bottom end and thus the end of the blade 2 that is directed away from the impeller forms a convex end face 8 formed by a part of a spherical surface, so that the blade 2 in the area that is directed away from the impeller forms a spherical cap or dome. The edges of the cutting edges 7 are situated in the end face 8, so that these are curved. A radius R of the end face 8 has its end directed away from the end face 8 on the axis of the pump shaft at the same level as the pump shaft bearing that is adjacent the pump impeller.

The nonrotating element 10 shown in FIGS. 4 and 5 has two sector-shaped flow-through openings 12 that work together by means of their edges with the cutting edges 7. In the second embodiment, the cross-sections of the flow-through openings 12 are larger on the end that is directed away from the impeller than on the end facing toward the impeller. This way, a safe transport of swelling solids, in particular of hygiene articles, is assured.

A counter surface 9 of a nonrotating element 10 abuts the end face 8, the element 10 forming a concave recess that is formed according to the end face 8 and thus possesses the same radius R, if a normally small gap between the surfaces 8 and 9 is neglected.

In the second design, the nonrotating element 10 is provided in its center between the flow-through openings 12 with an inlet tip 13 that is similar to the rotor cap and that projects to the inlet end (FIGS. 6 and 7), so as to avoid plugging of the cutter upstream of the cutting plane. By means of the inlet tip, solids, in particular textiles, are conveyed to the flow-through openings instead of remaining in the center between the flow-through openings in front of the nonrotating element.

The element 10 that is circular on its outer edge is mounted in an annular flange 11 that is attached in the pump housing, in particular screwed onto it. Element 10 and flange 11 can also be designed as an integral piece.

1. A cutter (1) of a rotary pump for liquids containing solid materials, the cutter having a rotating blade (2) having at least one opening (5) through which the liquid flows that forms a cutting edge and the blade is directed with one end face (8) toward a nonrotating counter surface (9) that also has at least one opening (12) through which the liquid flows, characterized in that the end face (8) of the blade (2) that directed toward the counter surface (9) is convex, whereas the counter surface (9) is complementarily concave.

2. The cutter according to claim 1, characterized in that the curvature of the blade (2) forms a spherical cap (dome).

3. The cutter according to claim 2, characterized in that an end of a radius (R) of the spherical cap is situated on an axis of the pump shaft at the same level as a shaft bearing that is near the pump impeller.

4. The cutter according to claim 1, characterized in that the rotating blade (2) is attached to the pump impeller at an end that is directed away from the counter surface (9).

5. The cutter according to claim 1, characterized in that the counter surface (9) is formed by a nonrotating element (10) that can be fixed in or on the pump housing or that is formed by the pump housing.

6. The cutter according to claim 1, characterized in that the flow-through openings (12) narrow in a flow direction and thus flare in a downstream direction.

7. The cutter according to claim 5, characterized in that the nonrotating element (10) is mounted in an annular flange (11) that can be attached in or on the pump housing.

8. The cutter according to claim 1, characterized in that the rotating blade (2) has two to four, preferably three sector-shaped openings (5).

9. The cutter according to claim 1, characterized in that the nonrotating element (10) has four to six, preferably five sector-shaped openings (12).

10. The cutter according to claim 1, characterized in that the cutting edges (7) of the in particular radial webs (6) are formed or supported between the openings (5) of the cutter (2).

11. The cutter according to claim 1, characterized in that it has an inlet tip (13) between the sector-shaped openings (12) of the nonrotating element.

12. The cutter according to claim 1, characterized in that the rotating blade (2) has the function of a further axial impeller due to the design of the intake ports 5 that extend at an angle relative to the rotational direction.
